(19) United States
(12) Patent Application Publication
(10) Pub. No.: US 2014/0131934 A1
(43) Pub. Date: May 15, 2014

(54) CLAMP FIXTURE AND RELATED CLAMP APPARATUS

(71) Applicant: WISTRON CORPORATION, New Taipei City (TW)

(72) Inventor: Xiu-Feng Cheng, New Taipei City (TW)

(73) Assignee: WISTRON CORPORATION, New Taipei City (TW)

(21) Appl. No.: 13/717,669

(22) Filed: Dec. 17, 2012

(30) Foreign Application Priority Data
Nov. 9, 2012 (CN) 201210448640.X

(51) Int. Cl. B25B 5/12

(52) U.S. Cl. CPC B25B 5/12
USPC 269/228

(57) ABSTRACT

A clamp fixture includes a base, a bridging component, an actuating component, a contacting component and a pushing component. The base is disposed on a foundation. A first end of the bridging component pivots to a first side of the base. A first end of the actuating component pivots to a second side of the base. The contacting component is disposed on a second end of the actuating component. The pushing component includes a body, two pivot structures and a handle. The pivot structures are disposed on an end of the body for respectively pivoting to the bridging component and the actuating component. The handle is disposed on the other end of the body. The handle moves at a first direction, the bridging component and the actuating component can move at a second direction, so as to move the contacting component close to or away from a work piece.

### BACKGROUND OF THE INVENTION

1. Field of the Invention

The present invention relates to a clamp fixture and a related clamp apparatus, and more particularly, to a clamp fixture and a related clamp apparatus with advantages of easy operation and preferable fixing efficiency.

2. Description of the Prior Art

For fixing a work piece, a conventional fixture utilizes screws or resilient components to provide constraint function. The conventional screw fixture uses a tool, such as the screw driver. The tool presses the screw to rotate, so as to lock the screw into the thread hole. The convention screw fixture has drawbacks of inconvenient operation and low operational efficiency, for example, a specific tool is applied to execute the locking and unlocking motion. The conventional resilient clamp fixture includes the resilient components, such as the spring and the resilient unit. The resilient component utilizes the resilient recovering force to press the work piece. However, the work piece is easily loosened when vibration of the work piece is violent or resilient fatigue of the resilient unit is generated, so the conventional resilient clamp fixture can not tightly fix the work piece. The conventional fixture can not stably fix the work piece, which decreases manufacturing accuracy of the processing procedure. Therefore, design of a clamp fixture with convenient operation and stable fixing force is an important issued in the mechanical industry.

### SUMMARY OF THE INVENTION

The present invention provides a clamp fixture with advantages of easy operation and preferable fixing efficiency and a related clamp apparatus for solving above drawbacks.

According to the claimed invention, a clamp fixture disposed on a foundation for fixing a work piece on the foundation is disclosed. The clamp fixture includes a base, a bridging component, an actuating component, a contacting component and a pushing component. The base is disposed on the foundation. The base includes a first side and a second side. The bridging component includes a first end and a second end. The first end of the bridging component pivots to the first side of the base. The actuating component includes a first end, a second end and a third end. The first end of the actuating component pivots to the second side of the base. The contacting component is disposed on the second end of the actuating component for contacting against the work piece. The pushing component is rotatably disposed on the bridging component and the actuating component. The pushing component includes a body, two pivot structures and a handle. The pivot structures are disposed on an end of the body. The pivot structures respectively pivot to the second end of the bridging component and the third end of the actuating component. The handle is disposed on the other end of the body relative to the pivot structures. The handle moves at a first direction, so the bridging component and the actuating component move at a second direction opposite to the first direction by the handle, to move the contacting component close to or away from the work piece.

According to the claimed invention, the pivot structures, the first end and the second end of the bridging component are substantially arranged as a straight when the contacting component contacts against the work piece.

According to the claimed invention, a distance between the first end and the second end of the bridging component is substantially greater than a distance between the pivot structures of the pushing component.

According to the claimed invention, a height of the second side of the base is substantially greater than a height of the first side of the base.

According to the claimed invention, a length of the handle is substantially greater than a distance between the pivot structures.

According to the claimed invention, the base further includes a constraining portion disposed on the first side. The constraining portion contacts against the pushing component to constrain rotation of the pushing component.

According to the claimed invention, the pivot structures, the first end and the second end of the bridging component are substantially arranged as a straight when the pushing component is blocked by the constraining portion.

According to the claimed invention, a clamp apparatus for fixing a work piece is disclosed. The clamp apparatus includes a foundation and a clamp fixture disposed on the foundation. The clamp fixture includes a base, a bridging component, an actuating component, a contacting component and a pushing component. The base is disposed on the foundation. The base includes a first side and a second side. The bridging component includes a first end and a second end. The first end of the bridging component pivots to the first side of the base. The actuating component includes a first end, a second end and a third end. The first end of the actuating component pivots to the second side of the base. The contacting component is disposed on the second end of the actuating component for contacting against the work piece. The pushing component is rotatably disposed on the bridging component and the actuating component. The pushing component includes a body, two pivot structures and a handle. The pivot structures are disposed on an end of the body. The pivot structures respectively pivot to the second end of the bridging component and the third end of the actuating component. The handle is disposed on the other end of the body relative to the pivot structures. The handle moves at a first direction, so the bridging component and the actuating component move at a second direction opposite to the first direction by the handle, to move the contacting component close to or away from the work piece.

The present invention can rapidly and stably fix and loose the work piece. The clamp fixture of the present invention utilizes the linkage to drive the contacting component to tightly press the work piece. The actuating component of the present invention can be constrained by a combination of the pushing component and the bridging component, the actuating component can not rotate relative to the base when the pushing component rotates relative to the bridging component at the predetermined angle (such as the straight arrangement of the first shaft, the third shaft and the fourth shaft), so that the contacting component can tightly press over the work piece. The reacting force from the work piece may generate a rotary moment at the first end of the actuating component, the combination of the pushing component and the bridging component can balance off the rotary moment, to effectively constrain the rotation of the actuating component relative to the base. Comparing to the prior art, the clamp fixture and the related clamp apparatus of the present invention has advantages of easy structure, simple operation and low manufacturing cost. The present invention can stably fix the work piece to advance the producing efficiency and the manufacturing accuracy, so as to increase the market competition of the product.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 and FIG. 2 respectively are diagrams of a clamp apparatus in different operational modes according to an embodiment of the present invention.

FIG. 3 is an exploded diagram of a clamp fixture according to the embodiment of the present invention.

FIG. 4 is a diagram of the clamp apparatus in an open mode according to the embodiment of the present invention.

FIG. 5 is a diagram of the clamp apparatus in a close mode according to the embodiment of the present invention.

### DETAILED DESCRIPTION

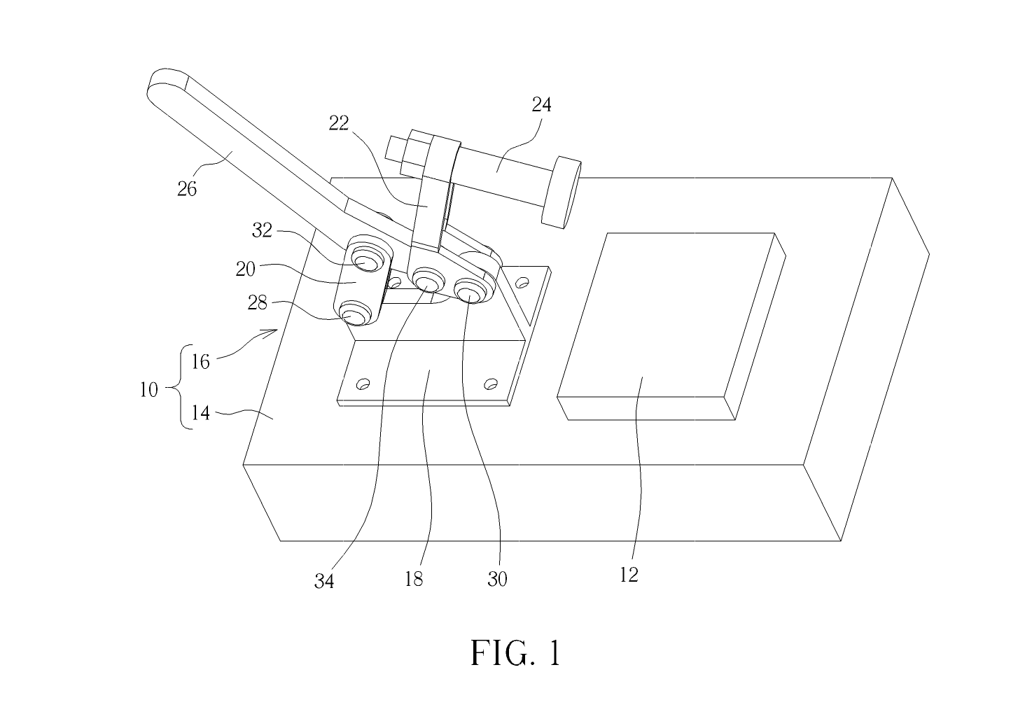

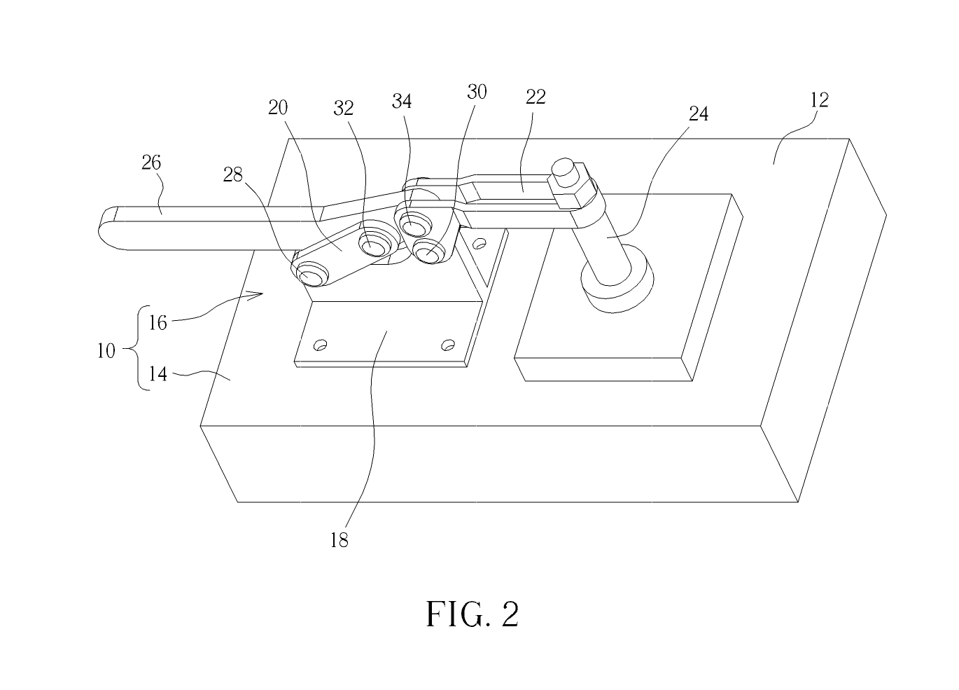

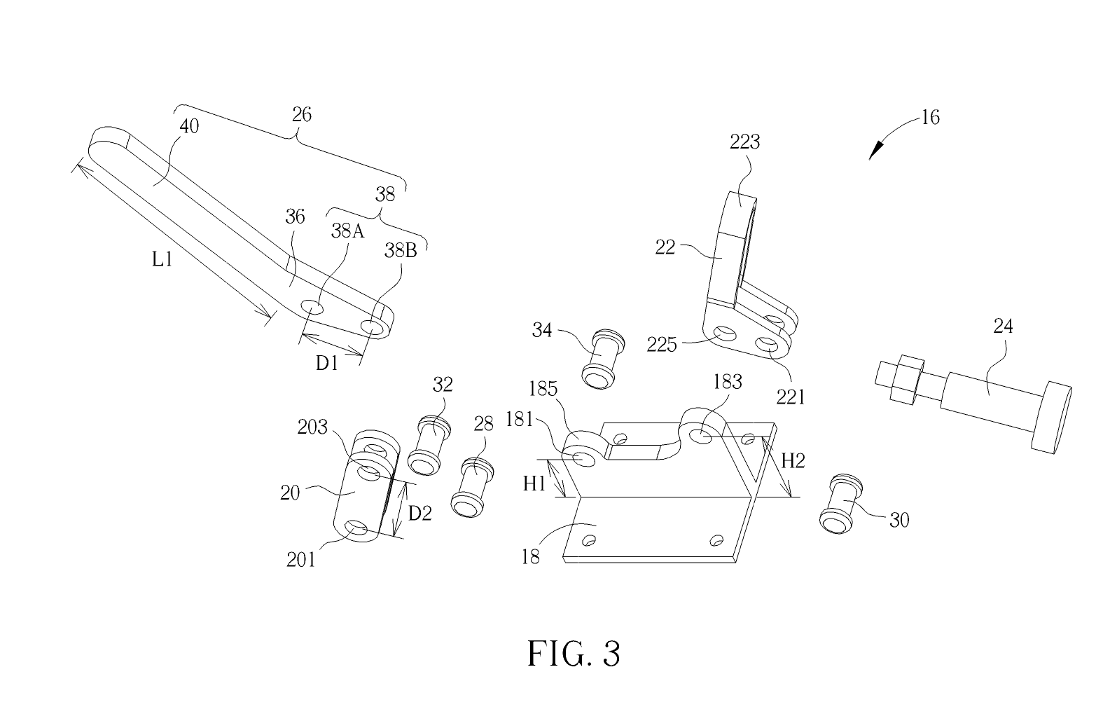

Please refer to FIG. 1 and FIG. 2. FIG. 1 and FIG. 2 respectively are diagrams of a clamp apparatus 10 in different operational modes according to an embodiment of the present invention. The clamp apparatus 10 can fix a work piece 12 to execute the processing procedure. The clamp apparatus 10 includes a foundation 14 and a clamp fixture 16. Please refer to FIG. 3. FIG. 3 is an exploded diagram of the clamp fixture 16 according to the embodiment of the present invention. The clamp fixture 16 is disposed on the foundation 14 to press the work piece 12 by linkage, so as to constrain a movement of the work piece 12 relative to the foundation 14.

As shown in FIG. 3, the clamp fixture 16 includes a base 18, a bridging component 20, an actuating component 22, a contacting component 24 and a pushing component 26. The base 18 is disposed on the foundation 14. The base 18 includes a first side 181 and a second side 183. The bridging component 20 includes a first end 201 and a second end 203. The actuating component 22 includes a first end 221, a second end 223 and a third end 225. The clamp fixture 16 further includes a first shaft 28, a second shaft 30, a third shaft 32 and a fourth shaft 34. The first shaft 28 passes through the first end 201 and the first side 181, and the bridging component 20 can pivot to the base 18. The second shaft 30 passes through the first end 221 and the second side 183, so that the actuating component 22 can pivot to the base 18.

The actuating component 22 can be an L-shaped structure. A part (the short part) of the L-shaped structure includes the first end 221 and the third end 225. The other part (the long part) of the L-shaped structure includes the second end 223. The contacting component 24 is disposed on the second end 223. When the work piece 12 is put on a surface of the foundation 14, the contacting component 24 can tightly contact against a surface of the work piece, which is relative to the foundation 14, by the linkage motion, so as to constrain the movement of the work piece 12 relative to the foundation 14. In addition, a risen angle of the contacting component 24 is greater as the short part of the actuating component 22 is shorter, so that the first end 221 and the third end 224 are preferably disposed on the short part of the L-shaped structure (the actuating component 22). A bending angle and dimensions of the L-shaped structure are not limited to the above-mentioned embodiment, and depend on actual demand.

The pushing component 26 includes a body 36, two pivot structures 38 and a handle 40. The pivot structures 38 and the handle 40 are respectively disposed on two ends of the body 36. When the third shaft 32 passes through the second end 203 and the pivot structure 38A (one of the pivot structures 38), the fourth shaft 34 passes through the third end 225 and the pivot structure 38B (the other one of the pivot structures 38), and the pushing component 26 can be rotatably connected to the bridging component 20 and the actuating component 22. Generally, a length L of the handle 40 can be substantially greater than a distance Dl between the pivot structures 38. The pushing component 26 can be driven easily to operate the clamp apparatus 10 to fix and to loose the work piece 12. A height H2 of the second side 183 of the base 18 can be substantially greater than a height H1 of the first side 181 of the base 18, so as to reduce the length of the short part of the actuating component 22, and the contacting component 24 of the clamp fixture 16 can rise taller.

As shown in FIG. 1 to FIG. 3, the base 18 can further includes a constraining portion 185 disposed on the first side 181. When the pushing component 26 rotates to fix the work piece 12, the pushing component 26 contacts against the constraining portion 185 after the pushing component 26 rotates at a predetermined angle. The constraining portion 185 can block the pushing component 26 to constrain rotation of the pushing component 26. Meanwhile, the pushing component 26 stops the bridging component 20 and the actuating component 22 to stabilize the linkage motion. It should be mentioned that the contacting component 24 can exactly contact the work piece 12 when rotation of the pushing component 26 is blocked by the constraining portion 185. The pivot structures 38, the first end 201 and the second end 203 of the bridging component 20 are substantially arranged as a straight, preferably.

A reacting force, which is generated because the contacting component 24 presses the work piece 12, points toward the first side 181 of the base 18 via the actuating component 22. Due to the straight arrangement of the first shaft 28, the third shaft 32 and the fourth shaft 34, the reacting force from the work piece 12 can not destroy constraint of the clamp fixture 16, so the work piece 12 is stable. For releasing the constraint of the clamp fixture 16, the pushing component 26 can be pulled or pushed to damage the straight arrangement of the first shaft 28, the third shaft 32 and the fourth shaft 34. The bridging component 20 and the actuating component 22 can rotate simultaneously to separate the contacting component 24 from the work piece 12. The distance D1 between the pivot structures 38 can be substantially smaller than a distance D2 between the first end 201 and the second end 203 of the bridging component 20, to prevent the clamp fixture 16 from structural interference.

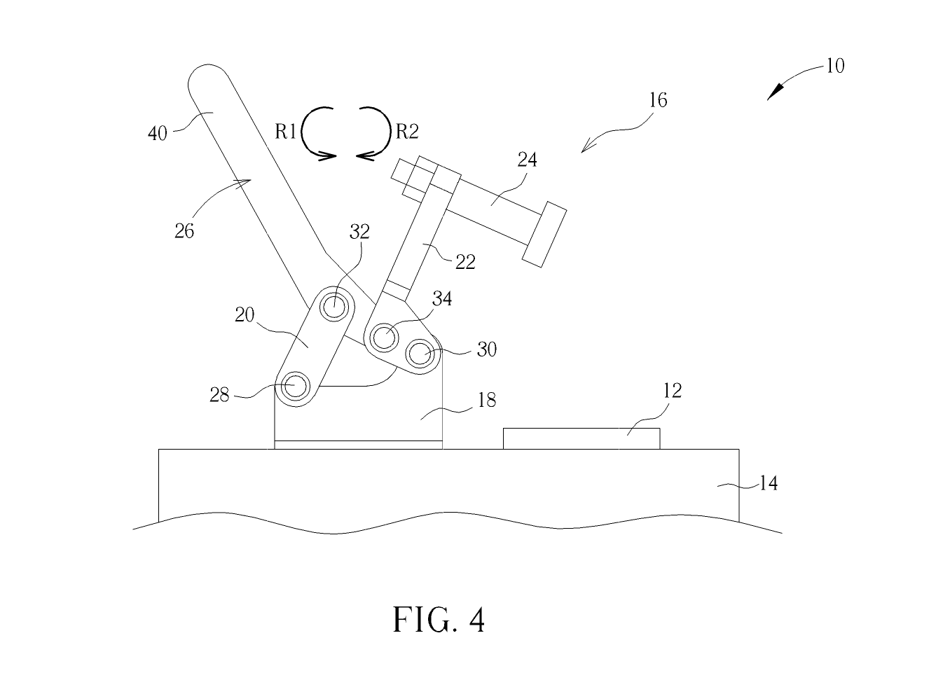

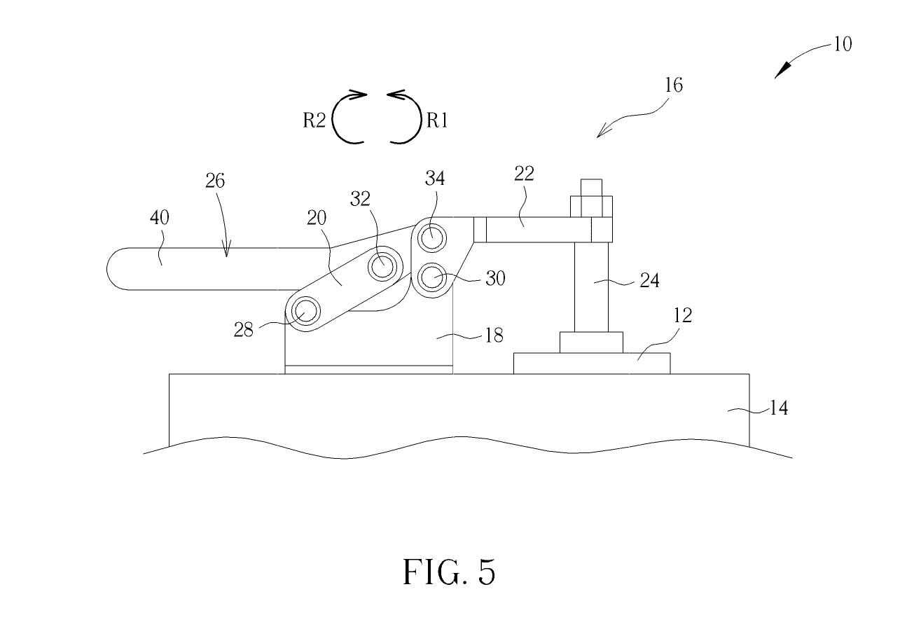

Please refer to FIG. 4 and FIG. 5. FIG. 4 is a diagram of the clamp apparatus 10 in an open mode according to the embodiment of the present invention. FIG. 4 is also a sectional view of FIG. 1. FIG. 5 is a diagram of the clamp apparatus 10 in a close mode according to the embodiment of the present invention. FIG. 5 is also a sectional view of FIG. 2. For fixing the work piece 12 by the clamp fixture 16, as shown in FIG. 4, the handle 40 can rotate at a first direction R1 (the counterclockwise direction), the pushing component 26 can guide the bridging component 20 and the actuating component 22 to rotate at a second direction R2 (the clockwise direction) opposite to the first direction R1 , the contacting component 24 moves toward the work piece 12 to press the work piece 12 on the foundation 14, as shown in FIG. 5. Besides, the pushing component 26 can rotate at the second direction R2 (the clockwise direction), and the pushing component 26 can drive the bridging component 20 and the actuating component 22 to rotate at the first direction R1 (the counterclockwise direction), so as to separate the contacting component 24 from the work piece 12 and to release the constraint of the clamp fixture 16, as shown in FIG. 5 to FIG. 4.

In conclusion, the present invention can rapidly and stably fix and loose the work piece. The clamp fixture of the present invention utilizes the linkage to drive the contacting component to tightly press the work piece. The actuating component of the present invention can be constrained by a combination of the pushing component and the bridging component, the actuating component can not rotate relative to the base when the pushing component rotates relative to the bridging component at the predetermined angle (such as the straight arrangement of the first shaft, the third shaft and the fourth shaft), so that the contacting component can tightly press over the work piece. The reacting force from the work piece may generate a rotary moment at the first end of the actuating component, the combination of the pushing component and the bridging component can balance off the rotary moment, to effectively constrain the rotation of the actuating component relative to the base. Comparing to the prior art, the clamp fixture and the related clamp apparatus of the present invention has advantages of easy structure, simple operation and low manufacturing cost. The present invention can stably fix the work piece to advance the producing efficiency and the manufacturing accuracy, so as to increase the market competition of the product.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A clamp fixture disposed on a foundation for fixing a work piece on the foundation, the clamp fixture comprising:
a base disposed on the foundation, the base comprising a first side and a second side;
a bridging component, the bridging component comprising a first end and a second end, the first end of the bridging component pivoting to the first side of the base;
an actuating component, the actuating component comprising a first end, a second end and a third end, the first end of the actuating component pivoting to the second side of the base;
a contacting component disposed on the second end of the actuating component for contacting against the work piece; and
a pushing component rotatably disposed on the bridging component and the actuating component, the pushing component comprising:
a body;
two pivot structures disposed on an end of the body, the pivot structures respectively pivoting to the second end of the bridging component and the third end of the actuating component; and
a handle disposed on the other end of the body relative to the pivot structures, the handle moving at a first direction, the bridging component and the actuating component moving at a second direction opposite to the first direction by the handle, so as to move the contacting component close to or away from the work piece.

2. The clamp fixture of claim 1, wherein the pivot structures, the first end and the second end of the bridging component are substantially arranged as a straight when the contacting component contacts against the work piece.

3. The clamp fixture of claim 1, wherein a distance between the first end and the second end of the bridging component is substantially greater than a distance between the pivot structures of the pushing component.

4. The clamp fixture of claim 1, wherein a height of the second side of the base is substantially greater than a height of the first side of the base.

5. The clamp fixture of claim 1, wherein a length of the handle is substantially greater than a distance between the pivot structures.

6. The clamp fixture of claim 1, wherein the base further comprises a constraining portion disposed on the first side, the constraining portion contacts against the pushing component to constrain rotation of the pushing component.

7. The clamp fixture of claim 6, wherein the pivot structures, the first end and the second end of the bridging component are substantially arranged as a straight when the pushing component is blocked by the constraining portion.

8. A clamp apparatus for fixing a work piece, the clamp apparatus comprising:
a foundation; and
a clamp fixture disposed on the foundation, the clamp fixture comprising:
a base disposed on the foundation, the base comprising a first side and a second side;
a bridging component, the bridging component comprising a first end and a second end, the first end of the bridging component pivoting to the first side of the base;
an actuating component, the actuating component comprising a first end, a second end and a third end, the first end of the actuating component pivoting to the second side of the base;
a contacting component disposed on the second end of the actuating component, the contacting component and the foundation respectively contacting against two opposite surfaces of the work piece; and
a pushing component rotatably disposed on the bridging component and the actuating component, the pushing component comprising:
a body;
two pivot structures disposed on an end of the body, the pivot structures respectively pivoting to the second end of the bridging component and the third end of the actuating component; and
a handle disposed on the other end of the body relative to the pivot structures, the handle moving at a first direction, the bridging component and the actuating component moving at a second direction opposite to the first direction by the handle, so as to move the contacting component close to or away from the work piece.

9. The clamp apparatus of claim 8, wherein the pivot structures, the first end and the second end of the bridging component are substantially arranged as a straight when the contacting component contacts against the work piece.

10. The clamp apparatus of claim 8, wherein a distance between the first end and the second end of the bridging component is substantially greater than a distance between the pivot structures of the pushing component.

11. The clamp apparatus of claim 8, wherein a height of the second side of the base is substantially greater than a height of the first side of the base.

12. The clamp apparatus of claim 8, wherein a length of the handle is substantially greater than a distance between the pivot structures.

13. The clamp apparatus of claim 8, wherein the base further comprises a constraining portion disposed on the first side, the constraining portion contacts against the pushing component to constrain rotation of the pushing component.

14. The clamp apparatus of claim 13, wherein the pivot structures, the first end and the second end of the bridging component are substantially arranged as a straight when the pushing component is blocked by the constraining portion.
